(19) United States
(12) Patent Application Publication
(10) Pub. No.: US 2012/0088657 A1
(43) Pub. Date: Apr. 12, 2012

(54) PRODUCT FOR USE IN AGRICULTURE OR HORTICULTURE

(75) Inventor: Franz Brandl, Basel (CH)

(73) Assignee: SYNGENTA CROP PROTECTION, LLC, Greensboro, NC (US)

(21) Appl. No.: 13/264,715

(22) PCT Filed: Apr. 13, 2010
(86) PCT No.: PCT/EP2010/054821

§ 371 Date: Dec. 28, 2011

(30) Foreign Application Priority Data
Apr. 14, 2009 (EP) 09005289.5
Sep. 9, 2009 (EP) 09169864.7

(51) Int. Cl. A01N 25/26; A01P 7/04; A01P 3/00

(52) U.S. Cl. 504/100

(57) ABSTRACT

The invention relates to a product for use in agriculture or horticulture comprising a capsule dissolving or disintegrating in the presence of humidity wherein at least a seed treated with an agrochemical compound is located.

The invention relates to a product for use in agriculture or horticulture and a method for manufacturing said product.

During treatment and further processing of seeds treated with a pesticide, especially seeds having a seed dressing containing the pesticide, these treated seeds generally produce dust containing the pesticide. Upon sowing of these seeds the dust may be liberated to the surrounding environment, which in turn may cause beneficial insects, like bees for example, to be exposed and killed by the pesticide in the dust. Also exposure of the operator handling the treated seeds may be an issue. This is very undesirable and the present invention aims to prevent these beneficial insects and the operators to be exposed to such dusts.

Accordingly, an object of the invention is a product for use in agriculture or horticulture comprising a capsule wherein at least a seed treated with an agrochemical compound is located.

The proposed product has the following advantages:
due to the capsule liberation of pesticide-containing dust of the treated seed is prevented, not only because it keeps the dust inside the capsule, but also because it prevents the formation of the dust due to abrasion between the treated seeds;
it is very flexible; additional components, like nutrients or fertilizers but also additional pesticides, for example, may be incorporated in any desired amounts;
it allows for an increased safety towards the people processing the treated seeds; there is no contact of the agrochemical compound with the user; granular, powder, viscous or liquid components may be used;
it allows for a simpler and more efficient storage and seeding of seeds as generally seeds like corn seeds come in various sizes, are screened and separated based on size and differently sized seeds are stored in a number of storage units, which can now be replaced by one storage unit for a single size, namely the size of the capsule;
the invention further enables simple application of various agricultural ingredients, like pesticides including micro-organisms like nitrogen-fixing bacteria, fertilizers, (micro)nutrients, etc.,
it also allows for separation of compounds that are phytotoxic to the seed, like certain fungicides and insecticides, from the seed, while preserving the benefit of these compounds to the emerging plant or seed.

The capsule useful for carrying out the invention may be a conventional capsule dissolving or disintegrating in the presence of humidity. Such capsules are, for example, used in medicinal arts to administer medicines. Such capsules may therefore be obtained using conventional techniques known in the art. As an indication, such capsules measure from 10 to 30 mm in length and have a diameter ranging from 10 to 25 mm, a preferred dimension being from 15 mm to 25 mm in length and 15 mm to 20 mm in diameter. The ratio of length to diameter is usually from 1:1 to 3:1. The material of the capsule is chosen so that it dissolves or disintegrates in the presence of humidity. It is preferred that such dissolution or disintegration occurs rather rapidly. It is also preferred that the capsule is gas and water permeable so that germination is not hindered. Suitable materials for such capsules are, for example, gelatin, starch, pullulan, hydroxypropylmethylcellulose and other cellulose derivatives. Preferred materials are starch, pullulan and hydroxypropylmethylcellulose.

In an embodiment of the invention the capsule comprises a water-permeable membrane. The membrane allows faster water entry into the capsule than the capsule material generally allows. Such a capsule may be a cup-shaped half of a conventional capsule having an open end and a closed end with a water-permeable membrane covering the open end. Alternatively, the capsule has two open ends with water-permeable membranes covering these open ends. The membrane may optionally be sealed. Examples of suitable water-permeable membranes include membranes made from gelatin, starch, carrageenan and cellulose derivatives.

Alternatively or additionally, the capsule comprises one or more holes. The size of the holes is such that water can readily enter the capsule, and dust is effectively kept within the capsule. The holes may be positioned near any one of the outer ends of the capsule. Prevention of dust-off can be improved by covering one or more of the holes with a water-absorbent material. Preferably all of the holes are covered with the water-absorbent material. The water-absorbent material may also be placed in between the treated seed and the holes. Examples of such water-absorbent material include non-ionic water-soluble polymers such as polyacrylamide, poloxyethylene, polyvinyl alcohol, and polyvinyl pyrrolidone; anionic polyelectrolytes such as polyacrylic acid, polyphosphoric acid, and polystyrene sulphonic acid; cationic polyelectrolytes such as polyethylene imine, polyvinyl amine and poly (4-vinyl pyridine), poly(4-vinyl-N-alkyl-pyridinium) salts, and poly(dimethyldiallylammonium chloride); sugars such as sucrose and disaccharide; and salts like magnesium sulfate and calcium chloride. Preferably, the water-absorbent materials are non-ionic water-soluble polymers, anionic polyelectrolytes and cationic polyelectrolytes.

The water-absorbent material may be applied onto a carrier such as silica, perlite or diatomaceous earth.

Seeds useful for carrying out the invention may be seeds coated according to known coating techniques, especially seeds having a seed dressing. In the context of the present application the language “seed dressing” refers to a coating onto a seed comprising an agrochemical composition, preferably at least one pesticide like an insecticide, a fungicide, a nematicide, a safener and/or another agrochemical compound, which is applied such that the shape of the seed is not considerably altered. The invention is particularly suitable for seeds of crops which generally have a seed dressing as these seeds are generally processed quickly and in large quantities which provides a higher abrasion risk and thus a higher risk of dust formation. Examples of such crops are cereals, such as wheat, barley, rye, oats, rice, maize (fodder maize and sugar maize/sweet and field corn) or sorghum; leguminous crops, such as beans, lentils, peas or soya; oil crops, such as oilseed rape, mustard, poppies, olives, sunflowers, coconut, castor, cocoa or ground nuts; tobacco and cotton. Preferred crops are Corn, Cereals (including Rice), Oil Seeds Rape & Canola, Soybean, Cotton, Sunflower, Beans, Sorghum, Peas, and Peanuts. In one embodiment of the invention the crops are selected from corn, soy and cereals. Suitable target crops also include transgenic crop plants of the foregoing types. Less preferred are seeds of crops which generally are pelletized, i.e. having a pellet coating as dust formation generally is not considered a problem due to the relatively light processing conditions, and therefore there is generally no need for additional measures to prevent dust liberation. Examples of such seeds include vegetable seeds, e.g. cabbage, lettuce and sugar beet, and flower seeds.

In an embodiment of the invention, the seeds are treated with part of the total amount of agrochemical compounds, the remaining part is applied to a separate body which is also located inside the capsule, and/or is applied to the inner wall of the capsule and/or is incorporated into the capsule material. The agrochemical compound applied to the seed can be the same or a different compound from the one applied to the separate body and/or the inner capsule wall and/or is incorporated into the capsule material. For example, the seed may be treated with an agrochemical in such a low amount that the agrochemical does not cause damage to the seed (i.e. is not phytotoxic to the seed). The agricultural product of the invention allows for application of one or more agrochemical compounds in amounts that exceed the maximum amount for each compound used for treating seeds. It may also allow application of one agrochemical compound to the seed and a second agrochemical compound to the separate body and/or the capsule inner wall and/or is incorporated into the capsule material. For example, the seed can be treated with a fungicide and the separate body and/or inner capsule wall with an insecticide and/or nematicide. It is advantageous that the seed is treated with a fungicide to allow immediate and local efficacy against fungicidal attack. The insecticide and/or the nematicide, and in particular the insecticides and/or nematicides that are systemic and/or are mobile in the soil (sufficient water solubility and/or appropriate soil adhesion), can be applied at a distance from the seed without considerable loss of insecticidal or nematicidal efficacy.

The agrochemical compounds to be used in the instant invention include herbicides, nematicides, fungicides and insecticides as well as plant growth regulators and inhibitors and plant activators. Preferred are agrochemical compounds which show systemic or mesostemic properties, which means such compounds are transported by the plant to different loci of the plant.

In one embodiment of the invention the agrochemical compound is an insecticide, a nematicide and/or a fungicide. The invention is particularly suitable for seeds treated with an insecticide.

In one embodiment of the invention the agrochemical compound is an insecticide which is selected from the group consisting of neonicotinoids, carbamates, diamides, spinosyns, phenylpyrazoles, pyrethroids, sulfoxaflor and spirotetramate. Examples of neonicotinoids are thiamethoxam, clothianidin, imidacloprid, acetamiprid, dinotefuran, nitenpyram and thiacloprid. Preferred neonicotinoids are thiamethoxam, imidacloprid and clothianidin. Examples of carbamates include thiodicarb, aldicarb, carbofuran, furadan, fenoxycarb, carbaryl, sevin, ethienocarb, and fenobucarb. Examples of diamides include chlorantraniliprole, cyantraniliprole, and flubendiamide. Examples of spinosyns include spinosad and spinetoram. Examples of pyrethoids include lambda-cyhalothrin, gamma-cyhalothrin, and tefluthrin. An example of phenylpyrazole is fipronil. Of these insecticides neonicotinoids are preferred.

In a further aspect of the invention the additional agrochemical compound is a nematicide. The nematicide can be any nematicide known in the art. Examples include an avermectin (e.g., abamectin), carbamate nematicides (e.g., aldicarb, thiadicarb, carbofuran, carbosulfan, oxamyl, aldoxycarb, ethoprop, methomyl, benomyl, alanycarb, iprodione), organophosphorus nematicides (e.g., phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, imicyafos), and certain fungicides, such as captan, thiophanate-methyl and thiabendazole. Also included as a nematicide is a compound of formula X,

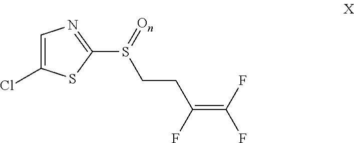

wherein n is 0, 1 or 2 and the thiazole ring may be optionally substituted. Abamectin, aldicarb, thiadicarb, dimethoate, methomyl, a compound of formula X and oxamyl are preferred nematicides for use in this invention.

In another embodiment of the invention, the agrochemical compound is a nematicidally active biological organism which is a bacterium or a fungus. Preferably, the biological organism is a bacterium. Examples of nematicidally active bacteria include Bacillus firmus, Bacillus subtilis, Bacillus cereus, Streptomyces spp., and Pasteuria spp. Examples of a preferred nematicidally active fungus include those from the genus Pochonia and especially the species Pochonia chlamydosporia. Suitable Bacillus firmus strains include strain CNCM I-1582 which is commercially available as BioNem™, strain ATCC 8247, ATCC 14575, NCIMB 13289, NCTC 6354, CN 2936, and ATCC 14414. It was found that strains ATCC 8247, ATCC 14575, NCIMB 13289, NCTC 6354, CN 2936, and ATCC 14414 exhibit nematicidal efficacy, which render these strains suitable for the present invention. Suitable Bacillus cereus strains include strain CNCM I-1562, strain ATCC 14579 and strain ATCC 10987. It was found that strains ATCC 14579 and ATCC 10987 exhibit nematicidal efficacy, which render these strains suitable for the present invention. Of Bacillus strains CNCM I-1582 and CNCM I-1562 more details can be found in U.S. Pat. No. 6,406,690. Suitable Streptomyces spp strains include Streptomyces strains capable of producing macrocyclic substances such as the bacterium Streptomyces avermitilis. Specific examples of Streptomyces strains are strain NRRL 8165, strain ATCC 31267, strain ATCC 31271, strain ATCC 31272, NRRL 5739, NC1B 11876, NC1B 11877, and NC1B 11878. Strains capable of producing avermectins, in particular abamectin, are preferred, which include Streptomyces avermitilis strains selected from strain NRRL 8165, strain ATCC 31267, strain ATCC 31271, and strain ATCC 31272. More details of the Streptomyces strains can be found in GB 2,122,089.

Suitable Pasteuria spp strains include Pasteuria penetrans and Pasteuria nishizawae.

In another embodiment of the invention the agrochemical is a fungicide, or a combination of an insecticide and a fungicide. Treating the seed with a fungicide is advantageous for preventing of dust-off of the fungicide, which allows for an appropriate fungicidal efficacy at the seed. Loss of the fungicide through dusting off may cause the amount of fungicide to be reduced to such a level that the fungicide is not sufficiently efficacious leading to fungal damage the seeds. The fungicide is preferably selected from azoxystrobin, trifloxystrobin, fluoxastrobin, cyproconazole, difenoconazole, prothioconazole, tebuconazole, triticonazole, fludioxonil, thiabendazole, ipconazole, cyprodinil, myclobutanil, metalaxyl, metalaxyl-M (also known as mefenoxam), amisulbrom, ametoctradin, boscalid, fluopyram, ilsotianil, penflufen, penthiopyrad, proquianazid, ortho-cyclopropyl-carboxanilide of formula (α)

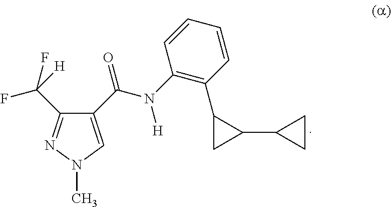

and a compound of formula (β)

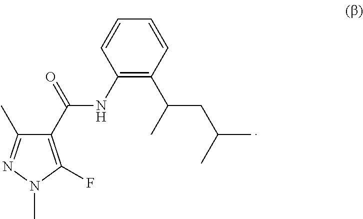

A further aspect of the invention is the addition of a further component into the capsule. The further component may be any component known in the art for use in agriculture or horticulture, and may, for example, be a nutrient or fertilizer. Such further component may also be a further agrochemical compound, such as a pesticide. Such further component may be a solid but also a viscous or liquid component.

The further component may also be a controlled release system, but for the purpose of the present invention such controlled release systems are generally absent as it generally requires the capsule to be larger than necessary. The controlled release system generally comprises an agrochemical compound, and may be in the form of a powder, granule, pellet, tablet, extrudate or any other form insuring the controlled release properties of the agrochemical compound. A preferred form of the controlled release system is a tablet. The tablet may be optionally coated with a polymer film coat. The controlled release system is, for example, a system which releases the agrochemical compound in a continuous manner over a prolonged period which may be several days to a whole growing season. Such controlled release system has to be contrasted by the conventional agrochemical formulations where all of the active ingredient is expected to be released immediately after application. Such controlled release may also take the form of no or very reduced initial release and a substantial release only after a certain period of time which may then be over a short period of time or in a prolonged way. Therefore, such controlled release system in form of a tablet, for example, does not need to be a homogeneous tablet but may comprise a core containing the agrochemical compound and a coating without such compound. In case of a controlled release system in form of an extrudate, an analogous configuration may be obtained by co-extrusion.

Typically, the controlled release system in form of a tablet comprises at least one agrochemical compound and a polymer, lipid or wax, either alone or in mixtures. In addition, the tablet may contain a variety of additives selected from the group consisting of diluents, lubricants, antiadherents and glidants. Some excipients can serve multiple purposes. The amount of the agrochemical compound in the controlled release system may vary widely. As an indication, the amount of the agrochemical compound is from 0.1 to 50% by weight of the controlled release system.

Examples of suitable polymer classes are ethylcellulose, cellulose acetate, cellulose acetate butyrate, polyhydroxybutyrate, polyacrylate, polymethacrylate, polyvinylchloride and polyhydroxybutyrate/polyhydroxyvalerate and others known in the art.

Examples of suitable lipidic ingredients are glyceryl palmitostearate, glyceryl tribehenate, stearic acid, stearyl alcohol and vegetable oil (e.g. canola, corn, cottonseed, sesame, soybean), hydrogenated vegetable oil (e.g. hydrogenated Cottonseed oil), vegetable wax and others known in the art.

Examples of suitable diluents or fillers are carbonates (calcium, magnesium), phosphates (calcium), sulfates (calcium), oxides (magnesium), chlorides (potassium, sodium), microcrystalline cellulose (e.g. Avicel™), starches, talc, kaolin, saccharides (dextrose, fructose, lactose, mannitol, sorbitol, sucrose) and others known in the art.

Examples of suitable lubricants are stearates (magnesium, calcium, zinc), glyceryl palmitostearate, glyceryl monostearate, lauryl sulfate, stearyl fumarate, talc, starches, stearic acid, hydrogenated vegetable oils (e.g. hydrogenated Cottonseed oil) and others known in the art.

Examples of suitable antiadherents are microcrystalline cellulose (e.g. Avicel™), colloidal silicon dioxide (e.g. Aerosil™), talc and others known in the art.

Examples of suitable glidants are powdered cellulose, magnesium trisilicate, colloidal silicon dioxide (e.g. Aerosil™), starches, talc and others known in the art.

The tablets useful in carrying out the invention may be obtained using conventional techniques. For example, after mixing, the components are compressed using conventional compression equipment, like a hydraulic press or a compression machine (eccentric or rotative).

A further aspect of the invention is the combination of two or more controlled release systems. Such release systems may comprise the same or different agrochemical compound and exhibit the same or different release profiles.

A further aspect of the instant invention is a method for manufacturing a product as herein described characterized that within a capsule is placed at least one seed treated with an agrochemical compound and optionally a further component whereafter the capsule is closed. The method may include or have added as a further step that the capsule is sealed. The preferred embodiments for the product apply in analogy to the method.

The invention is illustrated by the following Examples.

### EXAMPLES

Maize seeds treated with Maxim XL (0.1 liter per 100 kg seeds) were encapsulated in capsules made from hydroxypropyl methylcellulose, commercially available as Vcaps® ex Capsugel (Example 1), and in capsules made of pullulan, commercially available as NPcaps® ex Capsugel (Example 2). Both encapsulated (Examples 1 and 2) and non-encapsulated seeds were sown in sand and kept at 20° C. in a climate chamber. 5 g of water was added to every 100 g of sand. Over 90% of the encapsulated and the non-encapsulated seeds germinated.

The same test was repeated, except that the amount of water was 1.1 g per 100 g of sand. Similarly, germination rates over 90% were observed for both non-encapsulated and encapsulated seed.

Non-encapsulated and encapsulated treated maize seeds of Example 2 were sown in various soil types and corresponding watering as is indicated in the Table below. These experiments were conducted at 20° C. in a climate chamber.

TABLE 1

| | | Water amount | Germination rate |
|---|---|---|---|
| Maize seeds | Soil type | (g/100 g soil) | (%) |
| Non-encapsulated | Steinerde | 20 | >90 |
| | Drencherde | 12.5 | >90 |
| Example 2 | Steinerde | 20 | >90 |
| | Drencherde | 12.5 | >90 |

From the Table it can be deduced that the encapsulated seeds of Example 1 all have germination rates above 90% similar to the non-encapsulated seeds.

In the above experiments it is demonstrated that the encapsulated treated seeds of the invention are well suitable for commercial use. Formation of dust from the treated seeds is prevented when encapsulated in the capsules of Examples 1 and 2.

1. Product for use in agriculture or horticulture comprising a capsule dissolving or disintegrating in the presence of humidity wherein at least a seed treated with an agrochemical compound is located.

2. Product according to claim 1 wherein the seed comprises a seed dressing comprising the agrochemical compound.

3. Product according to claim 1 wherein the capsule material is starch, pullulan or hydroxypropylmethylcellulose.

4. Product according to claim 1 wherein the seed is selected from soy, corn and cereals.

5. Product according to claim 1 wherein the agrochemical product is an insecticide, preferably a neonicotinoid.

6. Product according to claim 1 wherein the agrochemical product is a fungicide.

7. Method for manufacturing a product according to claim 1 characterized in that within a capsule is placed at least one seed treated with an agrochemical compound whereafter the capsule is closed.

8. Method according to claim 6 characterized in that the capsule is sealed.
